(19) United States
(12) Patent Application Publication
(10) Pub. No.: US 2021/0279037 A1
(43) Pub. Date: Sep. 9, 2021

(54) TEMPORAL COMPUTING

(71) Applicant: TEMPORAL COMPUTING LTD, Ryton (GB)

(72) Inventor: Jonathan David Edwards, Ryton (GB)

(73) Assignee: TEMPORAL COMPUTING LTD, Ryton (GB)

(21) Appl. No.: 17/260,093

(22) PCT Filed: Aug. 7, 2019
(86) PCT No.: PCT/GB2019/052209

§ 371 Date: Jan. 13, 2021

(30) Foreign Application Priority Data
Aug. 8, 2018 (GB) 1812867.8

(51) Int. Cl. G06F 7/544; G06F 7/62; G06G 7/161; G06G 7/14

(52) U.S. Cl. CPC G06F 7/5443; G06G 7/14; G06G 7/161; G06F 7/62

(57) ABSTRACT

A system for evaluating a multiply and add expression. The system comprises an encoder for encoding variables of the multiply and add expression on a time domain signal divided into a plurality of time slots and comprising a first and second impulse on a first and second time slot. The system further comprises an integrator unit operable to receive the time domain signal on a time slot by time slot basis. The integrator unit is operable, to accumulate, on a time-slot-by-time-slot basis, an amplitude value corresponding to a running total of the sum of the amplitude of the impulse signals received, and accumulate, on a time-slot-by-time-slot basis, the accumulated amplitude value. The integrator unit is thereby operable to generate, after receipt of the time domain signal, a value which corresponds to the result of the multiply and add expression.

### TECHNICAL FIELD

The present invention relates to temporal computing techniques.

### BACKGROUND

Conventional computing techniques rely on data storage techniques in which data is stored in physical memory. Temporal Computation is an alternative method for implementing computation where the medium for storage is the time interval between signalling pulses known as Pulsed Interval Modulation (PIM).

Temporal computing techniques are thought to more closely match the neural activity of the brain. In certain circumstances temporal coding can be performed in hardware using actual time delays which has the potential to be more efficient and require less infrastructure than traditional binary digital coding and logic schemes.

### SUMMARY OF THE INVENTION

In accordance with a first aspect of the invention, there is provided a system for evaluating a multiply and add expression. The system comprises an encoder for encoding variables of the multiply and add expression on a time domain signal divided into a plurality of time slots and comprising a first and second impulse on a first and second time slot. The system further comprises an integrator unit operable to receive the time domain signal on a time slot by time slot basis. The integrator unit is operable, to accumulate, on a time-slot-by-time-slot basis, an amplitude value corresponding to a running total of the sum of the amplitude of the impulse signals received, and accumulate, on a time-slot-by-time-slot basis, the accumulated amplitude value. The integrator unit is thereby operable to generate, after receipt of the time domain signal, a value which corresponds to the result of the multiply and add expression.

Optionally, the multiply and add expression comprises a first multiplication expression (a.b) and a second multiplication expression (c.d) and is of the form (a.b)+(c.d).

Optionally, the encoder is operable to encode the variables of the multiply and add operation by using a first variable (a) of the first multiplication expression (a.b) to determine a time slot of the time domain signal on which an impulse signal of an amplitude determined by the second variable (b) of the first multiplication expression is present; and using a first variable (c) of the second multiplication expression (c.d) to determine a time slot of the time domain signal on which an impulse signal of an amplitude determined by the second variable (d) of the second multiplication expression is present.

Optionally, the integrator unit comprises an impulse accumulator unit to accumulate, on a time-slot-by-time-slot basis, the amplitude value corresponding to the running total of the sum of the amplitude of the impulse signals received.

Optionally, the integrator unit comprises a result accumulator unit to accumulate on a time-slot-by-time-slot basis, the accumulated amplitude value, and thereby generate, after receipt of the time domain signal, the value which corresponds to the result of the multiply and add expression.

In accordance with a second aspect of the invention, there is provided a calculation unit for evaluating a multiply and add expression, said unit arranged to receive a time domain signal divided into a plurality of time slots and comprising a first and second impulse on a first and second time slot and on which is encoded variables of the multiply and add expression. The calculation unit operable to accumulate, on a time-slot-by-time-slot basis, an amplitude value corresponding to a running total of the sum of the amplitude of the impulse signals received, and accumulate, on a time-slot-by-time-slot basis, the accumulated amplitude value, and thereby generate, after receipt of the time domain signal, a value which corresponds to the result of the multiply and add expression.

Optionally, the calculation unit further comprises an impulse accumulator unit to accumulate, on a time-slot-by-time-slot basis, the amplitude value corresponding to the running total of the sum of the amplitude of the impulse signals received.

Optionally, the calculation unit further comprises a result accumulator unit to accumulate on a time-slot-by-time-slot basis, the accumulated amplitude value, and thereby generate, after receipt of the time domain signal, the value which corresponds to the result of the multiply and add expression.

In accordance with a third aspect of the invention, there is provided a computer processor comprising a calculation unit according the second aspect of the invention.

In accordance with a fourth aspect of the invention, there is provided a method of evaluating a multiply and add expression. The method comprises: encoding variables of the multiply and add expression on a time domain signal divided into a plurality of time slots and comprising a first and second impulse on a first and second time slot; receiving the time domain signal on a time slot by time slot basis; accumulating, on a time-slot-by-time-slot basis, an amplitude value corresponding to a running total of the sum of the amplitude of the impulse signals received; accumulating, on a time-slot-by-time-slot basis, the accumulated amplitude value, and generating, after receipt of the time domain signal, a value which corresponds to the result of the multiply and add expression.

Optionally, the multiply and add expression comprises a first multiplication expression (a.b) and a second multiplication expression (c.d) and is of the form (a.b)+(c.d).

Optionally, encoding variables of the multiply and add expression on a time domain signal comprises: using a first variable (a) of the first multiplication expression (a.b) to determine a time slot of the time domain signal on which an impulse signal of an amplitude determined by the second variable (b) of the first multiplication expression is present, and using a first variable (c) of the second multiplication expression (c.d) to determine a time slot of the time domain signal on which an impulse signal of an amplitude determined by the second variable (d) of the second multiplication expression is present.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIGS. 1a, 1b and 1c provide diagrams illustrating a technique for populating an indexed array for evaluating a multiply and add expression of the form (a×b)+(c×d);

FIG. 2 provides a schematic diagram providing a graphical depiction of a process for performing an addition and cumulation operation for evaluating a multiply and add expression of the form (a×b)+(c×d);

FIG. 3 provides a schematic diagram depicting a hardware implementation for performing an addition and cumulation operation for evaluating a multiply and add expression described with reference to FIG. 2;

FIG. 4 provides a schematic diagram of a time domain signal on which is temporally stored an indexed array for performing an addition and cumulation operation for evaluating a multiply and add expression;

FIG. 5 provides a schematic diagram of a calculation unit for performing a multiply and add operation using the time domain signal depicted in FIG. 4, and

FIG. 6 provides a flowchart of a process for performing an addition and cumulation operation for evaluating a multiply and add expression.

### DETAILED DESCRIPTION

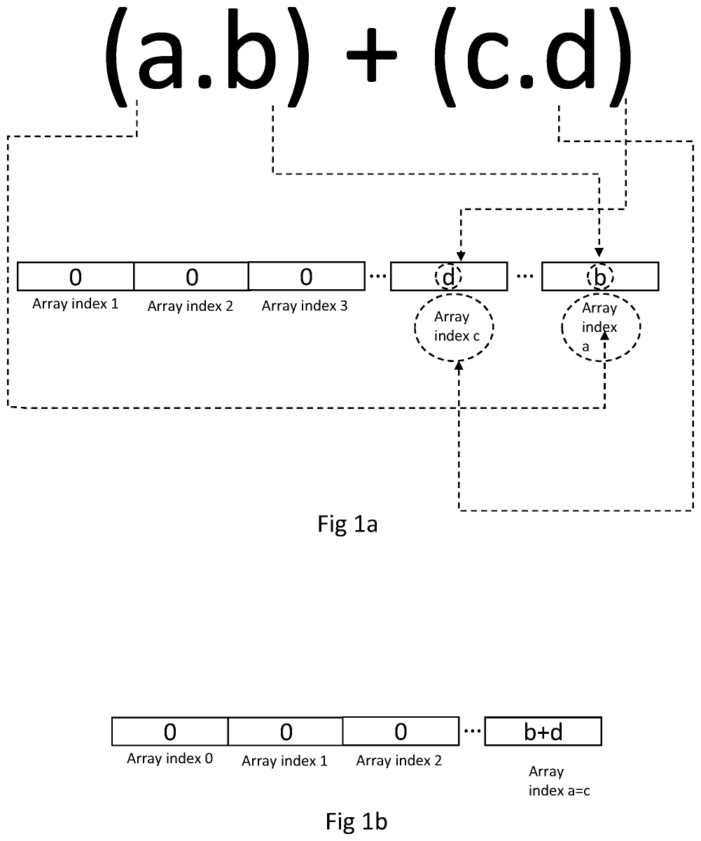

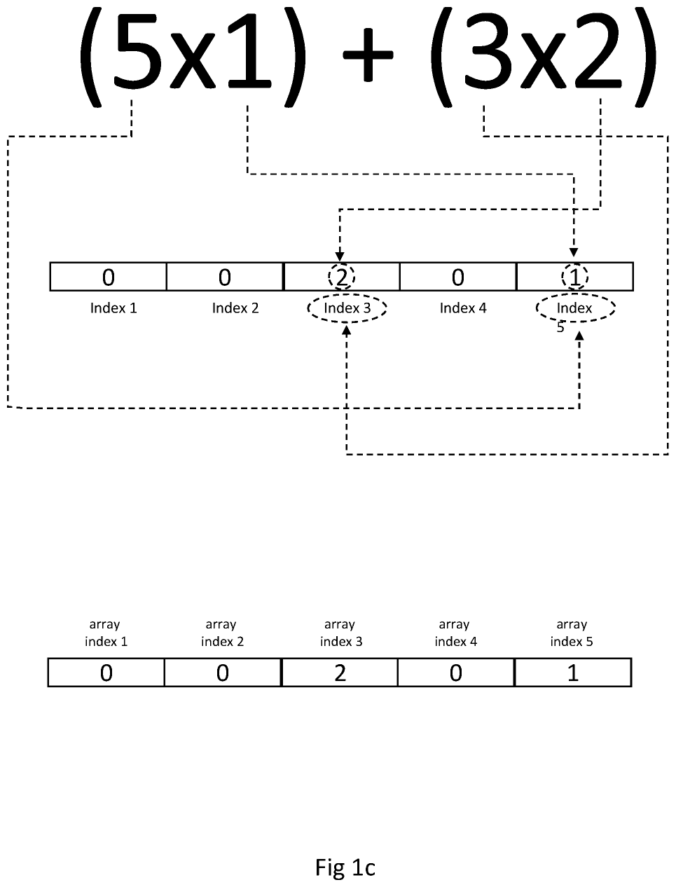

FIG. 1a provides a diagram illustrating a technique for populating an indexed array for undertaking an operation for evaluating an expression of the form (a×b)+(c×d). That is, an expression that sums the result of two multiplication expressions. Such expressions are also referred to as “dot product” expressions.

The operation involves applying an addition and accumulation operation to an indexed array of values generated from the variables of each multiplication expression to evaluate the multiplication expression.

The indexed array is created by using one variable from each multiplication expression to specify an array index of an array element and the other variable from the multiplication expression to specify an array value of the array element at that array index.

The indexed array, thus formed, is subject to an accumulation operation in which, starting with the array element with the highest array index, the values of each array element are sequentially accumulated to provide an evaluation result. The evaluation result is the result of the expression.

FIG. 1a provides a diagram depicting the technique for generating the indexed array in general form.

A multiply and add operation of the form (a×b)+(c×d) is shown.

A first variable from the first multiplication expression (a) is used to specify an array index (array index a) of a first array element (as will be understood an array index specifies a particular array element within the array).

The second variable from the first multiplication expression (b) is used to specify the value of the array element at the array index specified by the first variable. Thus, array element (a) has an array value of (b).

A second variable from the second multiplication expression (c) is used to specify an array index (array index c) of a second array element. The second variable from the second multiplication expression (d) is used to specify the value of the array element at the array index specified by the first variable. Thus, array element (c) has an array value of (d).

As will be understood, the larger value of each variable from each multiplication expression used to specify the array index will determine the total length of the indexed array. Thus, if a is greater than c, the indexed array will be a array elements long. Alternatively, if c is greater than a, then the indexed array will be c array elements long. In the example shown in FIG. 1a, a is shown to be larger than c.

If the variables defining array index are the same (e.g. if a=c), then the array value at the array element at array index a=c is the sum of the other variables (e.g. b+d). This is shown in FIG. 1b.

The technique for array generation is illustrated further with reference to FIG. 1c.

With reference to FIG. 1c, the expression (5×1)+(3×2) is considered (i.e. with a=5; b=1; c=3, and d=2).

The expression comprises two multiplication expressions a first multiplication expression: 5×1, and a second multiplication expression: 3×2.

Each multiplication expression has two variables. For clarity, these are referred to as a left-hand variable and a right-hand variable.

The left-hand variable of the first multiplication expression is 5 and the left-hand variable of the second multiplication expression is 3. The largest of these variables (5 in this case), determines the total length of the array.

FIG. 1c depicts five array elements (a first array element at array index 1, a second array element at array index 2, a third array element at array index 3, a fourth array element at array index 4 and a fifth array element at array index 5).

The array indexes are numbered from left to right, i.e. with the left-most array element corresponding to array index 1 and the right-most array element corresponding to array index 5.

One of the array indexes corresponds to the left-hand variable of the first multiplication expression (in this case 5), i.e. array index 5. One of the other array indexes corresponds to the right-hand variable of the second multiplication expression (in this case 3), i.e. array index 3. These array indexes (i.e. array index 5 and array index 3) each have a value associated with them. More specifically, they are associated with a value that corresponds to the other number of their respective multiplication expressions. Thus, the array element at array index 5 is associated with the value 1 (because the first multiplication expression is 5×1) and the array element at array index 3 is associated with the value 2 (because the second multiplication expression is 3×2). Each of the other array elements at the other array indexes (i.e. the array elements at array indexes 1, 2 and 4) are associated with a zero value.

In this way, an indexed array of values is formed, i.e. 0, 0, 2, 0, 1.

As shown in FIG. 1c, for clarity, from left to right, the array elements are referred to as array element 1, array element 2, array element 3, array element 4 and array element 5.

An addition and cumulation operation is performed using the indexed array which produces an evaluation result for the expression.

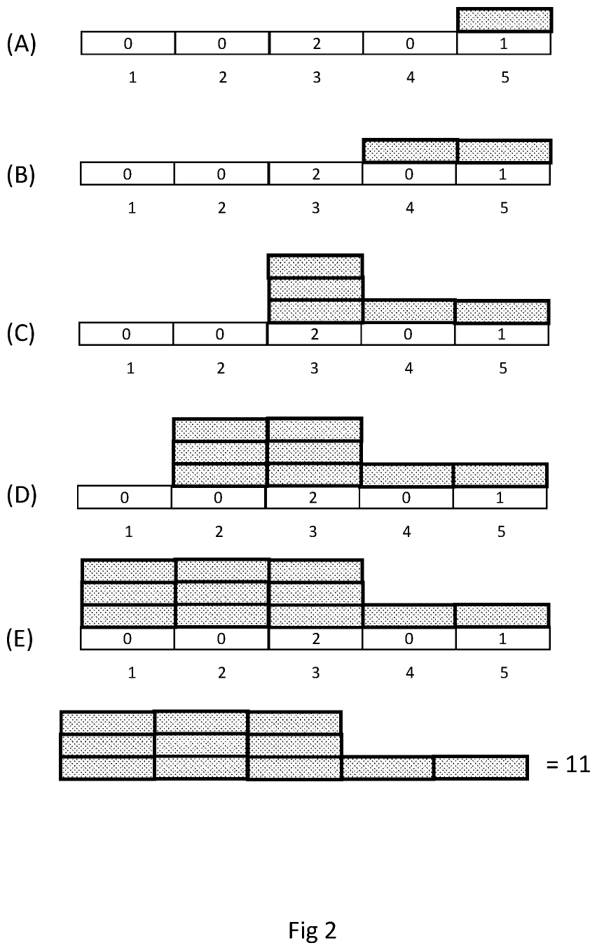

A graphical depiction of this operation is shown in FIG. 2.

At a first step (A), array element 5 (corresponding to array index 5) is evaluated. The evaluation comprises taking the integer value associated with array element 5. In the example explained from FIG. 1c, this is the integer 1. This gives a first evaluation result of 1.

At a second step (B), array element 4 is evaluated (corresponding to array index 4). This evaluation comprises adding the integer value of this array element to the evaluation result for array element 5. This evaluation therefore comprises the addition 0+1=1.

At a third step (C), array element 3 is evaluated (corresponding to array index 3). This evaluation comprises adding the integer value of this array element to the evaluation result for array element 4. This evaluation therefore comprises the addition 1+2=3.

At a fourth step (D), array element 2 is evaluated (corresponding to array index 2).

This evaluation comprises adding the integer value of this array element to the evaluation result for array element 3. This evaluation therefore comprises the addition 3+0=3.

At a fifth step (E), array element 1 is evaluated (corresponding to array index 1). This evaluation comprises adding the integer value of this array element to the evaluation result for array element 2. This evaluation therefore comprises the addition 3+0=3.

Finally, at a sixth step, the evaluation results for each array element are accumulated (i.e. 1+1+3+3+3) giving the result for the multiply and add expression which is 11.

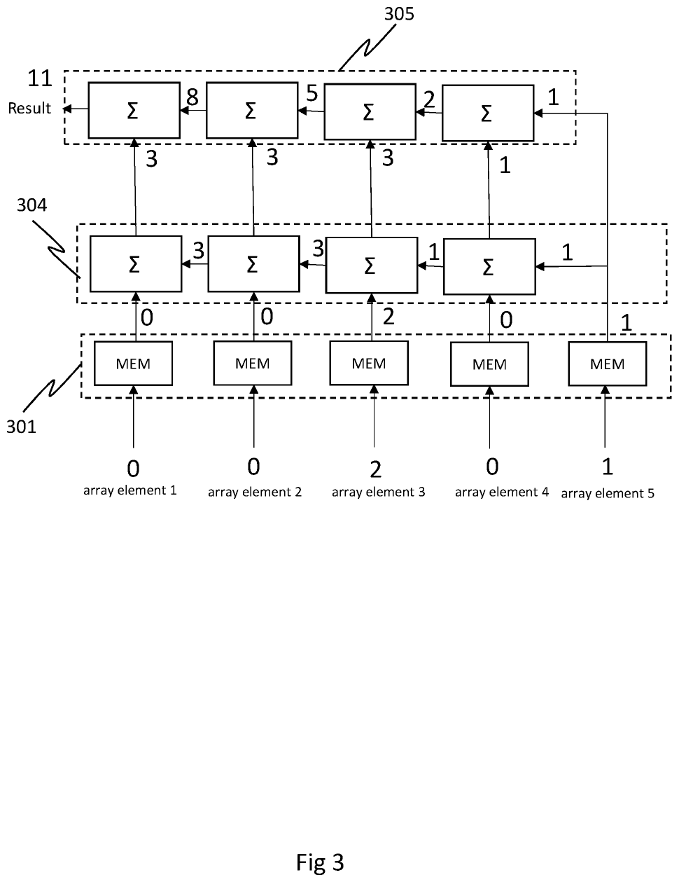

FIG. 3 provides a schematic diagram depicting a hardware implementation for implementing the addition and cumulation operation described above.

A memory array 301 is provided comprising a number of memory units, each memory unit corresponding to an array element as described above. Each memory unit holds a value corresponding to the integer value of the array element to which it corresponds. Thus, a fifth memory unit 302 holds the value 1 and the third memory unit 303 holds the value 3. The remaining memory units hold the value zero.

The hardware implementation includes a first array of sequential adder units 304 and a second array of sequential adder units 305. The adder units of the first array of sequential adder units 304 generate the evaluation value corresponding to each array element (i.e. 3, 3, 1, 1 and 1) and the second array of sequential adder units 305 sequentially accumulate these evaluation values to provide the result of the multiply and add expression. To illustrate this process, the integer values input to and output from the adder units are shown in FIG. 3.

When performing a multiply and add operation of the form (a×b)+(c×d) using the technique described above with reference to FIGS. 1 and 2 using the hardware implementation shown in FIG. 3, the indexed array must be read into the memory array 301 ahead of the addition and accumulation operations undertaken by the first and second array of sequential adders.

This requires the indexed array to be stored in a physical memory medium.

However, in accordance with examples of a temporal computing technique, the indexed array required to perform the multiply and add operation can be stored temporally, i.e. in the time domain, using pulsed interval modulation (PIM). In other words, variables of the expression are encoded on a time domain signal.

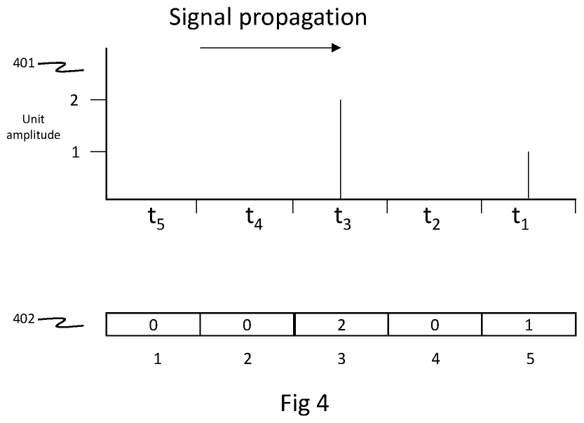

This is shown in FIG. 4.

FIG. 4 shows a time domain signal 401 divided into a number of time slots. In certain examples, the signal will be multiplexed on a carrier signal (not shown).

Each time slot of the time domain signal corresponds to an array element of the indexed array 402, and conveys an impulse signal corresponding to the integer value associated with the corresponding array element. The signal is shown propagating in time from left to right, accordingly, the first time slot (t₁) corresponds to the fifth array element and has an impulse with amplitude 1; the third time slot (t₃) corresponds to the third array element and has an impulse with amplitude 2 and the remaining time slots (t₁, t₂ and t₄) have zero amplitude, i.e. carry no impulse.

As described above, the time domain signal “stores” the indexed array (by variables of the expression being encoded on the time domain) and can be input to suitable hardware to implement the multiply and add operation. In other words, the index array is mimicked by a sequentially ordered medium (i.e. time).

An example of such hardware is a calculation unit which on reception of the signal begins an accumulator which performs two accumulation operations: a first accumulation operation which accumulates the amplitude of the impulse signals on a time-slot-by-time-slot basis and a second accumulator which accumulates the accumulated amplitude from the first operation on a time-slot-by-time-slot basis to accumulate the final result.

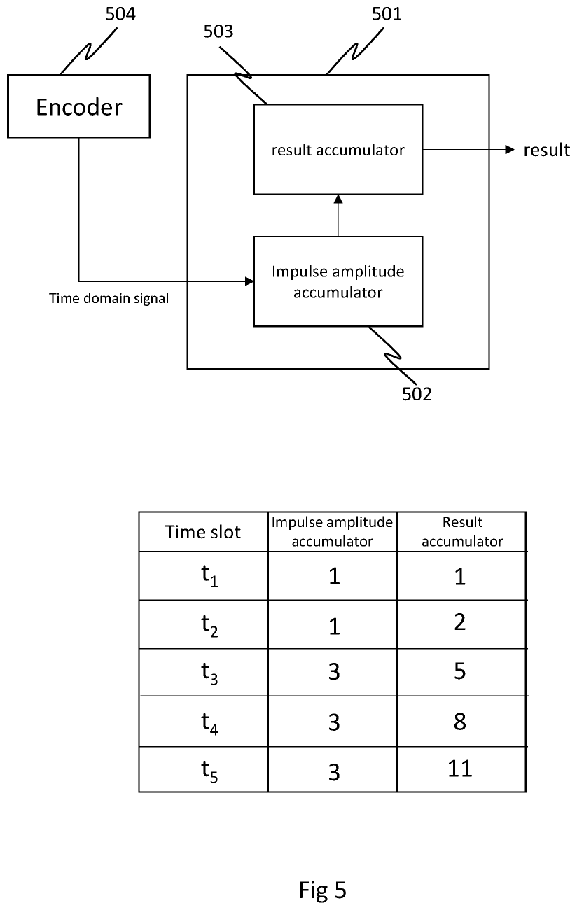

FIG. 5 provides a schematic diagram of such a calculation unit 501 which includes an impulse amplitude accumulator 502 and a result accumulator 503. The calculation unit 501 receives the time domain signal from an encoder 504 which encodes the expression to be evaluated as a time domain signal.

With reference to the time domain signal 401 shown in FIG. 4 and the table shown in FIG. 5, during the first time slot t₁, the calculation unit receives the first impulse with amplitude 1. The impulse accumulator 502 accumulates this value (i.e. stores the value 1) and passes this value to the result accumulator 503. The result accumulator 503 stores the value 1. As can be seen from the time domain signal 401 shown in FIG. 4, during the second time slot t₂, the calculation unit 501 receives no impulse. The impulse accumulator 502 therefore maintains the previous value (i.e. 1) and passes this value to the result accumulator 503. The result accumulator 503 adds this to the previous value and thus stores the value 2. As can be seen from the time domain signal 401 shown in FIG. 4, during the third time slot t₃, the calculation unit 501 receives the second impulse with amplitude 2. The impulse accumulator 502 adds this to the previously accumulated impulse value (i.e. 1+2=3) and passes this value 3 to the result accumulator 503. The result accumulator 503 adds this to the previous value and thus stores the value 5. As can be seen from the time domain signal 401 shown in FIG. 4, during the fourth time slot t₄, the calculation unit 501 receives no impulse.

The impulse accumulator 502 therefore maintains the previous value (i.e. 3) and passes this value to the result accumulator 503. The result accumulator 503 adds this to the previous value and thus stores the value 8. As can be seen from the time domain signal 401 shown in FIG. 4, during the fifth time slot t₅, the calculation unit 501 receives no impulse. The impulse accumulator 502 therefore maintains the previous value (i.e. 3) and passes this value to the result accumulator 503. The result accumulator 503 adds this to the previous value and thus stores the value 11.

This final result can then be read from the result accumulator. As will be understood, using a hardware arrangement as depicted in FIG. 5, and a time domain signal on which variables of the expression are encoded, a multiply and add expression can be performed without the need to store an indexed array in physical memory.

Typically, operation of the impulse amplitude accumulator 502 and the result accumulator 503 are governed by operation of a common clock signal to maintain synchronisation. Typically, the time domain signal which is input to the calculation unit is also generated in synchronisation with this clock signal.

The impulse amplitude accumulator 502 and the result accumulator 503 can be implemented using suitable electronics well-known in the art. The calculation unit 501 can be implemented as part of a larger computing system.

In accordance with certain embodiments, a method of evaluating a multiply and add expression is provided in which a multiply and add expression is evaluated by encoding variables of the expression on a time domain signal. More specifically, as described above, the time domain signal is generated which encodes a multiply and add expression of the form (a×b)+(c×d). The format of the time domain signal corresponds to the format of the indexed array described above whereby each array element of the indexed array corresponds to a time slot of the time domain signal, and impulse are present on the time domain signal in time slot positions correspond to the non-zero array elements of the indexed array.

In accordance with this method, the time domain signal is received on a time slot by time slot basis. An amplitude value corresponding to a running total of the sum of the amplitude of the impulse signals received and accumulated on a time-slot-by-time-slot basis. The accumulated amplitude value is, itself, accumulated on a time-slot-by-time-slot basis. After receipt of the time domain signal, a value which corresponds to the result of the multiply and add expression.

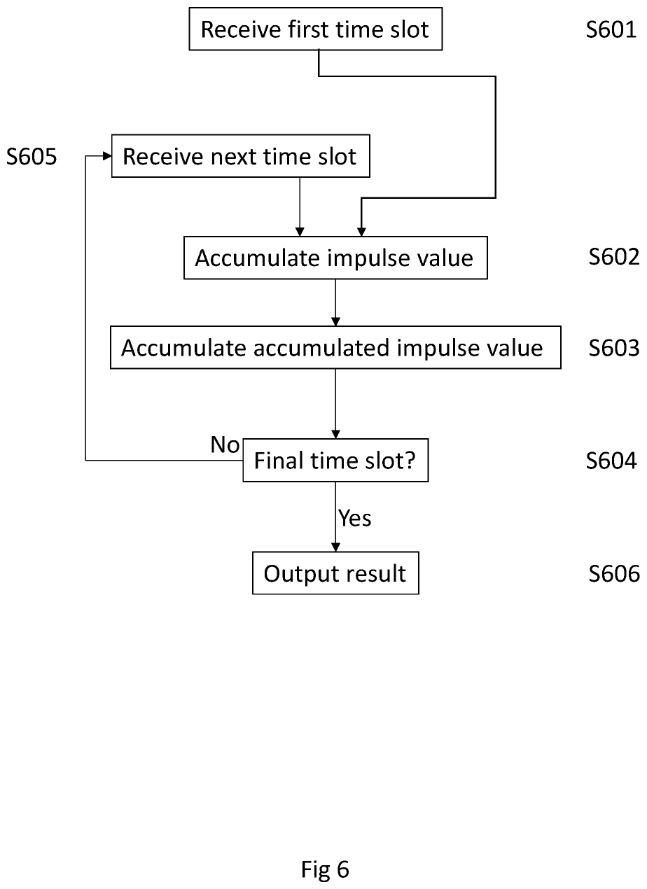

FIG. 6 provides a schematic diagram of a flow chart setting out an example implementation of this method.

At a first step S601 the first time slot of the time domain signal is received. At a second step S602 the impulse value of all the time slots so far received is accumulated to generate an accumulated impulse value. At a third step S603, the accumulated impulse value is accumulated. At a fourth step, S604 it is determined if the last time slot has been received. If the last slot has not been received, a fifth step S605 is performed where the next time slot is received and then the second step S602, third step S603 and fourth step S604 are repeated.

If at the fourth step, it is determined that the last slot has been received, then a sixth step S606 is performed whereby the value of all the accumulated impulse values is output as the evaluation result of the expression.

In the system described with reference to FIG. 5, the process is undertaken by a computing unit comprising an impulse amplitude accumulator and result accumulator. However, it will be understood that this process can be undertaken by any suitable hardware arrangement designed and arranged using techniques known in the art.

In certain examples, a calculation unit as described above can be provided as part of a larger processing unit (for example as part of an arithmetic logic unit (ALU) or floating-point logic unit (FPU) of a central processing unit (CPU) or graphics processing unit (GPU).

All the features disclosed in this specification (including any accompanying claims, abstract and drawings), and/or all the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A system for evaluating a multiply and add expression comprising:
an encoder for encoding variables of the multiply and add expression on a time domain signal divided into a plurality of time slots and comprising a first and second impulse on a first and second time slot, an integrator unit operable to receive the time domain signal on a time slot by time slot basis, wherein the integrator unit is operable, to:
accumulate, on a time-slot-by-time-slot basis, an amplitude value corresponding to a running total of the sum of the amplitude of the impulse signals received, and
accumulate, on a time-slot-by-time-slot basis, the accumulated amplitude value, and thereby generate, after receipt of the time domain signal, a value which corresponds to the result of the multiply and add expression.

2. A system according to claim 1, wherein the multiply and add expression comprises a first multiplication expression (a.b) and a second multiplication expression (c.d) and is of the form (a.b)+(c.d).

3. A system according to claim 1, wherein the encoder is operable to encode the variables of the multiply and add operation by:
using a first variable (a) of the first multiplication expression (a.b) to determine a time slot of the time domain signal on which an impulse signal of an amplitude determined by the second variable (b) of the first multiplication expression is present, and
using a first variable (c) of the second multiplication expression (c.d) to determine a time slot of the time domain signal on which an impulse signal of an amplitude determined by the second variable (d) of the second multiplication expression is present.

4. A system according to claim 1, wherein the integrator unit comprises an impulse accumulator unit to accumulate, on a time-slot-by-time-slot basis, the amplitude value corresponding to the running total of the sum of the amplitude of the impulse signals received.

5. A system according to claim 1, wherein the integrator unit comprises a result accumulator unit to accumulate on a time-slot-by-time-slot basis, the accumulated amplitude value, and thereby generate, after receipt of the time domain signal, the value which corresponds to the result of the multiply and add expression.

6. A calculation unit for evaluating a multiply and add expression, said unit arranged to receive a time domain signal divided into a plurality of time slots and comprising a first and second impulse on a first and second time slot and on which is encoded variables of the multiply and add expression, said calculation unit operable to:
accumulate, on a time-slot-by-time-slot basis, an amplitude value corresponding to a running total of the sum of the amplitude of the impulse signals received, and
accumulate, on a time-slot-by-time-slot basis, the accumulated amplitude value, and thereby generate, after receipt of the time domain signal, a value which corresponds to the result of the multiply and add expression.

7. A calculation unit according to claim 6, further comprising an impulse accumulator unit to accumulate, on a time-slot-by-time-slot basis, the amplitude value corresponding to the running total of the sum of the amplitude of the impulse signals received.

8. A calculation unit according to claim 7, further comprising a result accumulator unit to accumulate on a time-slot-by-time-slot basis, the accumulated amplitude value, and thereby generate, after receipt of the time domain signal, the value which corresponds to the result of the multiply and add expression.

9. A computer processor comprising a calculation unit according to claim 6.

10. A method of evaluating a multiply and add expression, said method comprising:
encoding variables of the multiply and add expression on a time domain signal divided into a plurality of time slots and comprising a first and second impulse on a first and second time slot;
receiving the time domain signal on a time slot by time slot basis;
accumulating, on a time-slot-by-time-slot basis, an amplitude value corresponding to a running total of the sum of the amplitude of the impulse signals received;
accumulating, on a time-slot-by-time-slot basis, the accumulated amplitude value, and
generating, after receipt of the time domain signal, a value which corresponds to the result of the multiply and add expression.

11. A method according to claim 10, wherein the multiply and add expression comprises a first multiplication expression (a.b) and a second multiplication expression (c.d) and is of the form (a.b)+(c.d).

12. A method according to claim 10, wherein encoding variables of the multiply and add expression on a time domain signal comprises:
using a first variable (a) of the first multiplication expression (a.b) to determine a time slot of the time domain signal on which an impulse signal of an amplitude determined by the second variable (b) of the first multiplication expression is present, and
using a first variable (c) of the second multiplication expression (c.d) to determine a time slot of the time domain signal on which an impulse signal of an amplitude determined by the second variable (d) of the second multiplication expression is present.
